(19) United States
(12) Patent Application Publication
(10) Pub. No.: US 2025/0248338 A1
(43) Pub. Date: Aug. 7, 2025

(54) Hay Skid

(71) Applicant: Charlie Dylla, Adkins, TX (US)

(72) Inventor: Charlie Dylla, Adkins, TX (US)

(21) Appl. No.: 19/046,217

(22) Filed: Feb. 5, 2025

Related U.S. Application Data
(63) Continuation of application No. 63/549,800, filed on Feb. 5, 2024.

(51) Int. Cl. A01D 85/00; A01D 90/12

(52) U.S. Cl. CPC A01D 85/005; A01D 90/12

(57) ABSTRACT

A hay skid and method of using the hay skid to haul hay. The hay skid is placed onto a trailer, allowing the hay skid to be used with conventional trailers. The hay skid has at least one hay basket that is rotationally connected to the frame of the hay skid. The hay basket is locked to prevent rotation for loading and hauling hay. The hay basket is unlocked to allow rotation at the desired location. The hay basket is rotated to off-load the hay bale.

### CROSS-REFERENCES TO RELATED APPLICATIONS

This application claims the benefit of the filing date of provisional application No. 63/549,800, the entirety of which is incorporated by reference herein.

### STATEMENT REGARDING FEDERALLY SPONSORED RESEARCH OR DEVELOPMENT

Not applicable.

### BACKGROUND OF THE INVENTION

### 1. Field of the Invention

The present invention relates to a novel design for a hay skid. More specifically, the present invention is a mechanism for hauling and unloading hay bales using a conventional trailer.

### 2. Description of the Related Art

Hay bales are commonly transported by trailers, trucks or tractors. One common mechanism for hauling hay is a trailer specifically fabricated for, and only suitable for, hauling hay bales.

### BRIEF SUMMARY OF THE INVENTION

The present invention is novel hay skid. The hay skid can be mounted on a trailer which is towed behind a tractor or truck.

The hay skid comprises a frame, at least one hay basket, at least one locking rod, and at least one release mechanism.

In an exemplary embodiment described herein, the hay skid comprises three hay baskets. Each basket is rotationally mounted to the frame of the skid. During loading and transport, the hay baskets are locked into place using a locking rod. When the user is ready to unload a hay bale, a hay basket is unlocked by rotating a lever attached to the locking rod. Once the locking rod is removed from a corresponding slot, the basket can rotate respective to the frame which causes the hay bale to fall to the ground.

### BRIEF DESCRIPTION OF THE SEVERAL VIEWS OF THE DRAWINGS

FIG. 1 is a side view of the hay skid without any hay loaded and the hay baskets in the load position.

FIG. 2 is a front angle view of the hay skid installed on a trailer and with hay loaded onto the hay skid.

FIG. 3 is a blown-up view of a locking rod and handle in the locked position.

FIG. 4 is a blown-up view of a locking rod and handle in the unlocked position.

FIG. 5 is side view of a hay basket in the open (unload) position.

FIG. 6 is a side angle view of the hay skid installed on a trailer with the hay baskets in the closed position.

FIG. 7 is an environmental view showing the hay skid being installed on a trailer using a tractor.

### DETAILED DESCRIPTION OF THE INVENTION

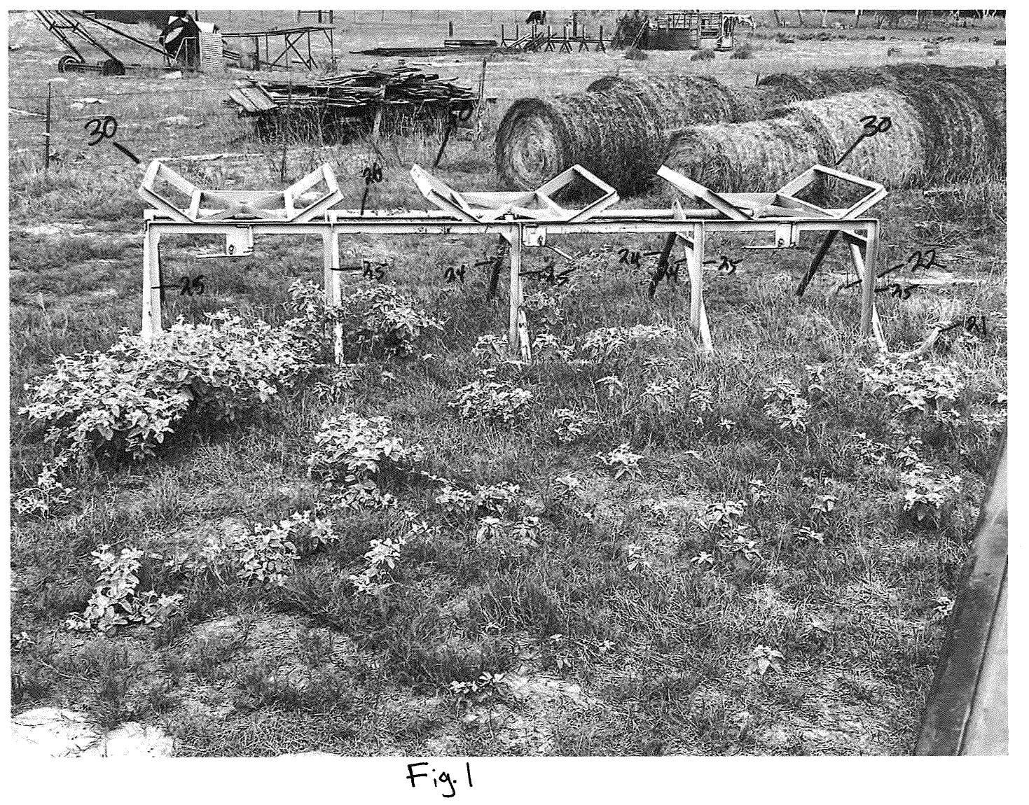

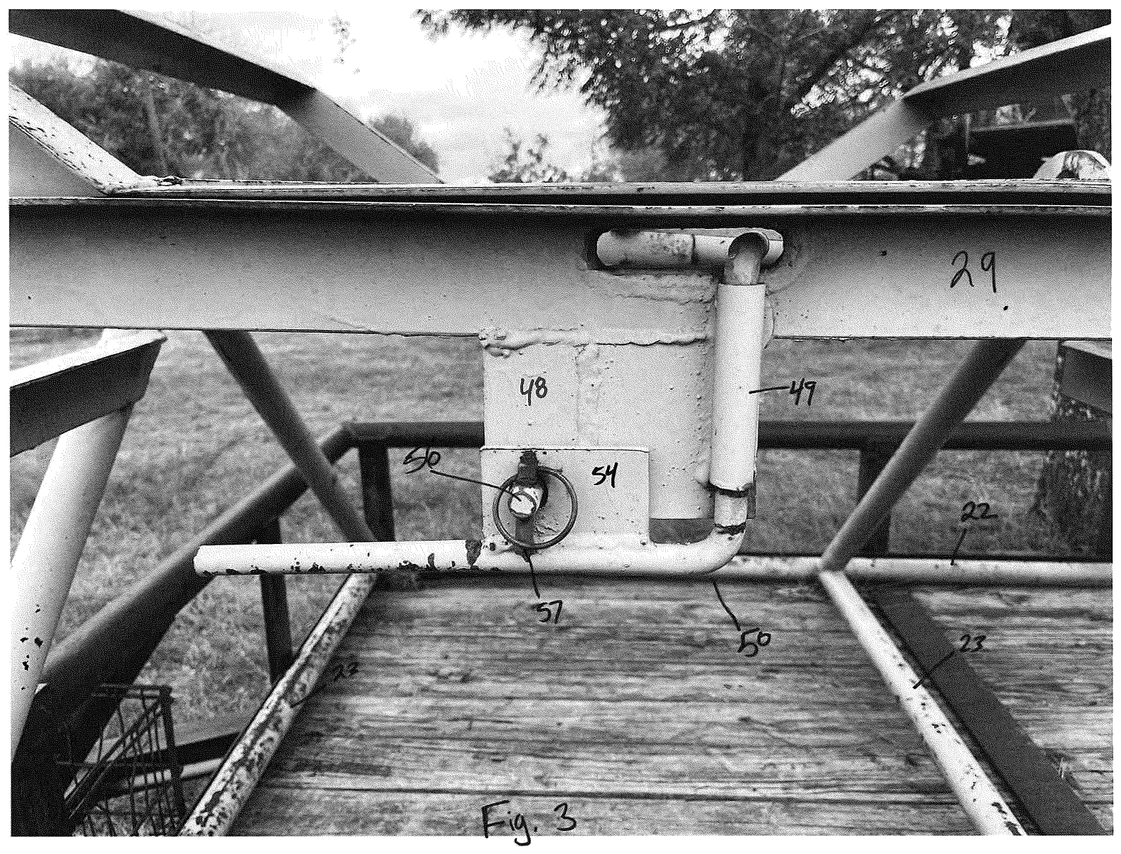

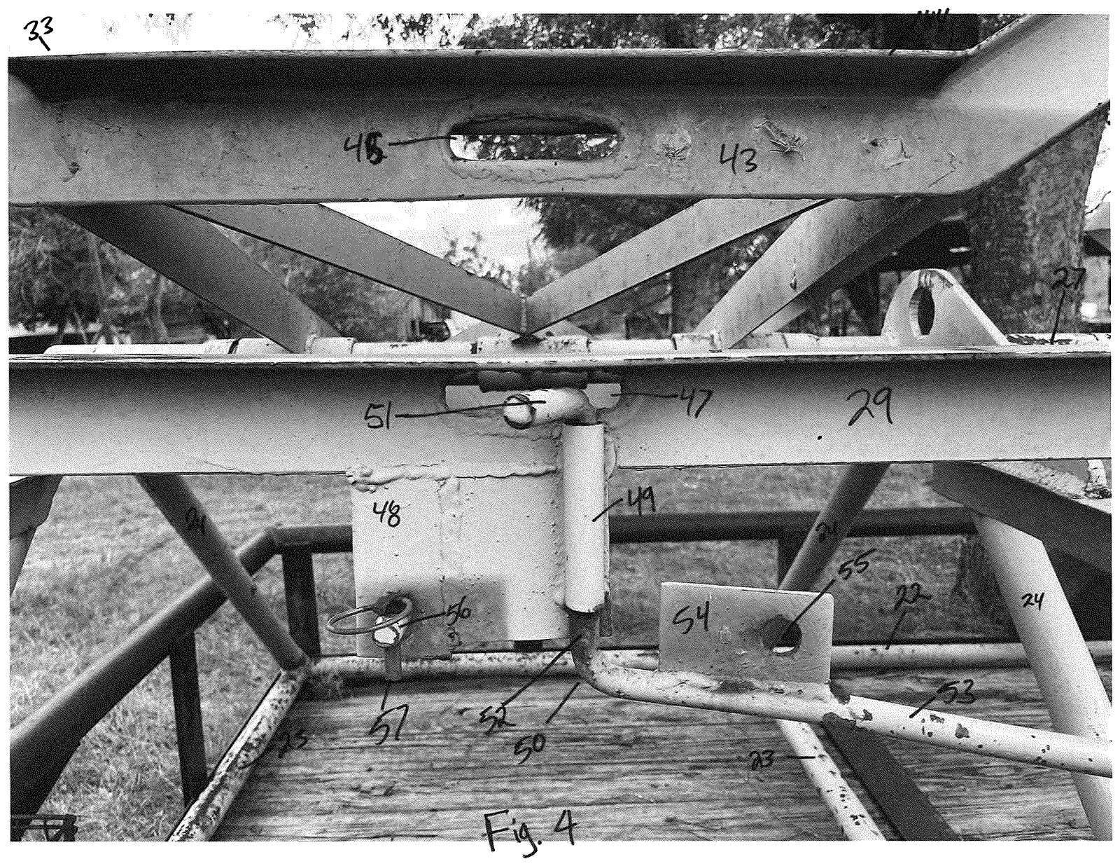

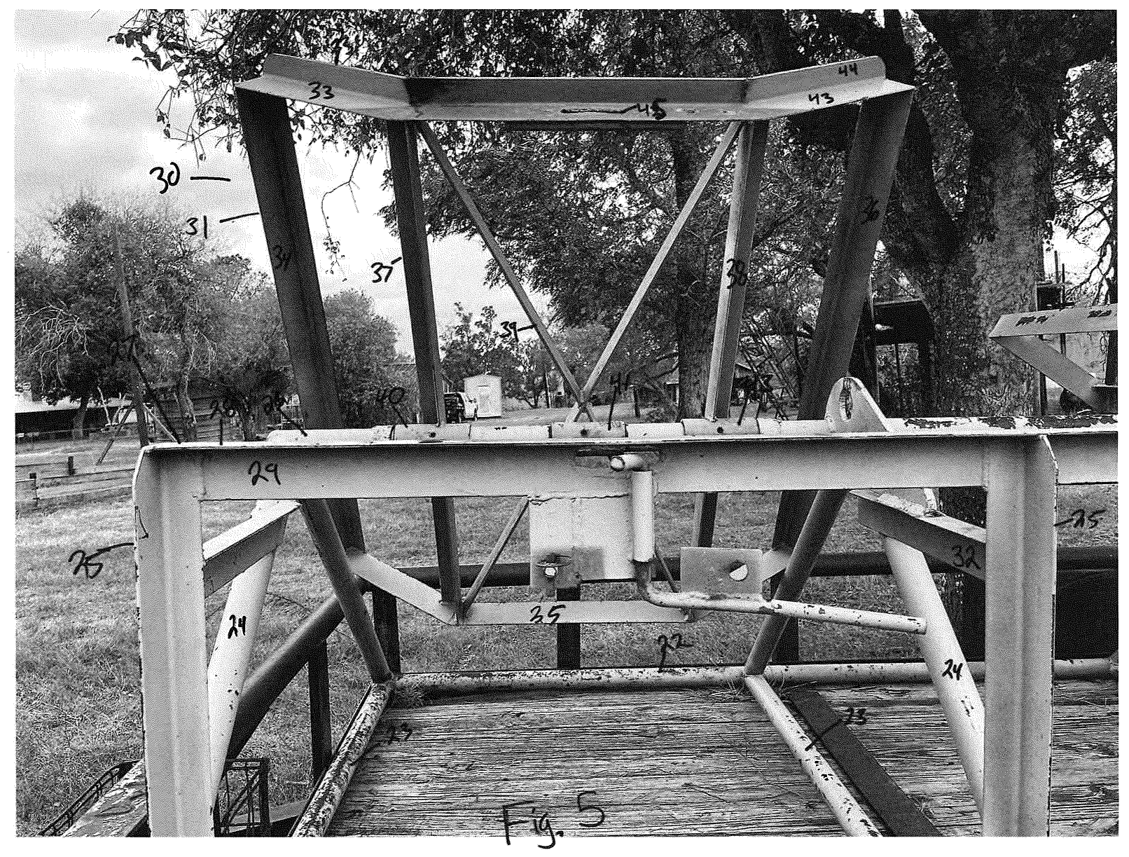

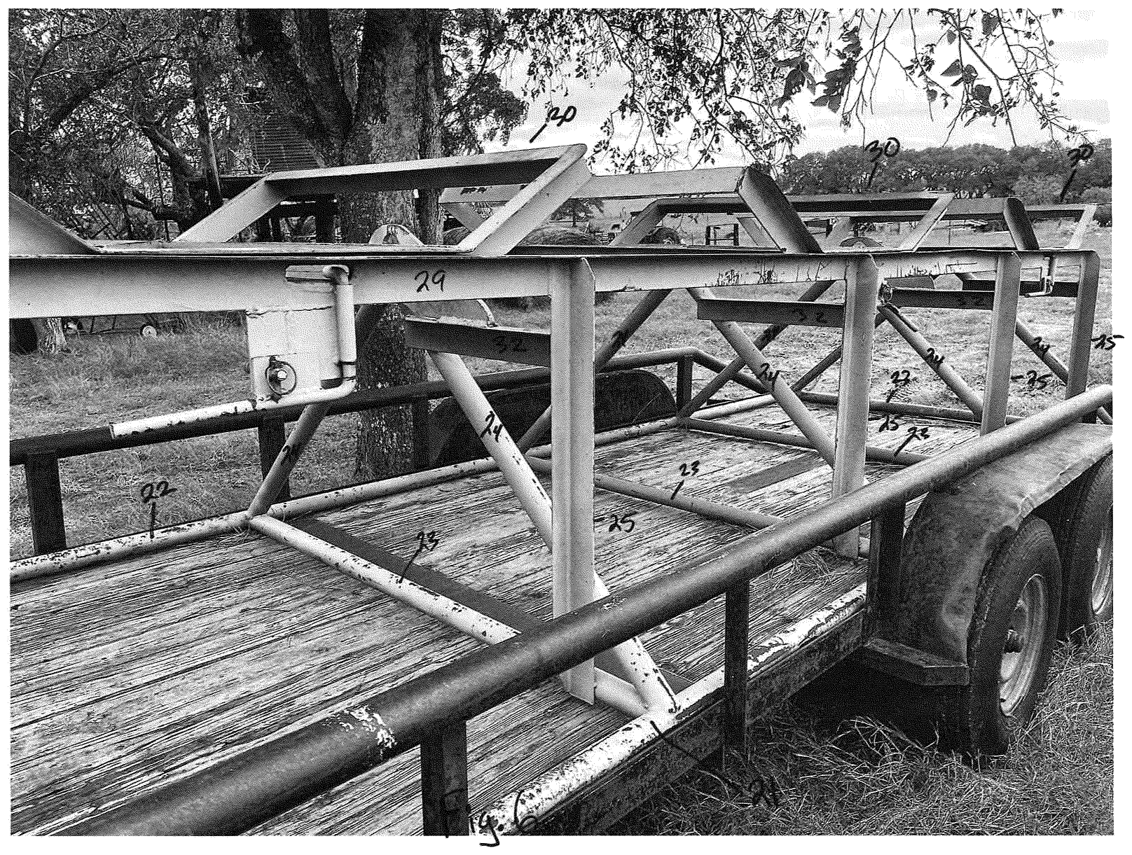

The structure of an embodiment 20 of the hay skid is described with reference to FIGS. 1-6.

The hay skid 20 comprises a frame having a first base beam 21 and a second base beam 22. Crossbeams 23 extend between the base beams 21 and 22. A-frame supports 24 are integral the cross beams 23 and the base beams 21 22. The A-frame supports 24 extend upward, angularly, from the cross beams 23 and base beams 21 22. A cylindrical shaft 26 is integral the top of the A-frame 24 supports.

Vertical L-beam stanchions 25 extend upward, perpendicularly, from each cross beam 23. The L-beam stanchions 25 are proximate the joinder of the cross beam 23 and the first base beam 21, but slightly interior so that there is gap between the stanchion 25 and the first base beam 21. Additional L-beam supports 32 connect each stanchion 25 to the A-frame supports 24 proximate the top of the A-frame supports 24.

A top crosspiece L-beam 27 is integral the tops of the stanchions 25. The top crosspiece 27 comprises a top portion 28 and a side portion 29.

A hay basket 30 comprises a frame 31. The frame 31 comprises a first side 33, second side 34, third side 35, and fourth side 36, a first cross beam 37, support lattice 39, and second cross beam 38.

The hay basket 30 further comprises a first cylindrical collar 40 integral the bottom of the first cross beam 37, a second cylindrical collar 41 integral the bottom side of the support lattice 38, and a third cylindrical collar 42 integral the bottom side of the second cross beam 39.

The inner diameter of the collars 40, 41, and 42 is slightly larger than the outer diameter of the cylindrical shaft 26. The collars 40, 41, and 42 form a rotational fit around the cylindrical shaft 26, allowing the basket 30 to be rotatable relative the shaft 26.

The first side 33 of the frame 31 is a flared L-beam, having a side portion 43 and a top portion 44. A locking rod slot 45 is cut through the side surface 43 of the first side 33 of the frame 31.

The crosspiece L-beam 27 extends comprises a top surface 28 and a side surface 29. A locking rod slot 47 is cut through the side surface 29 of the of the crosspiece L-beam 27.

A flange 48 is integral the side surface 29 of the crosspiece-beam 27, proximate the locking rod slot 47. A locking rod chute 49 is integral the flange 48 and/or the side surface 29. A security post 56 extends from the flange 48. The security post 56 has a cylindrical aperture in which a locking pin 57 can be inserted.

A locking rod 50 is rotationally enclosed within the locking chute 49. The locking rod 50 comprises a first horizontal section 51, a vertical section 52, a second horizontal section 53, and a security flange 54. The security flange comprises an aperture 55.

They hay skid 20 may comprise additional hay baskets 30 according to the design described herein. For each additional hay basket 30, the hay skid comprises additional corresponding locking rod slots 47, flanges 48, locking rod chutes 49, security posts 56, and locking rods 55 according to the description provided herein. In the embodiment depicted in the Figures, the hay skid 20 has three hay baskets 30.

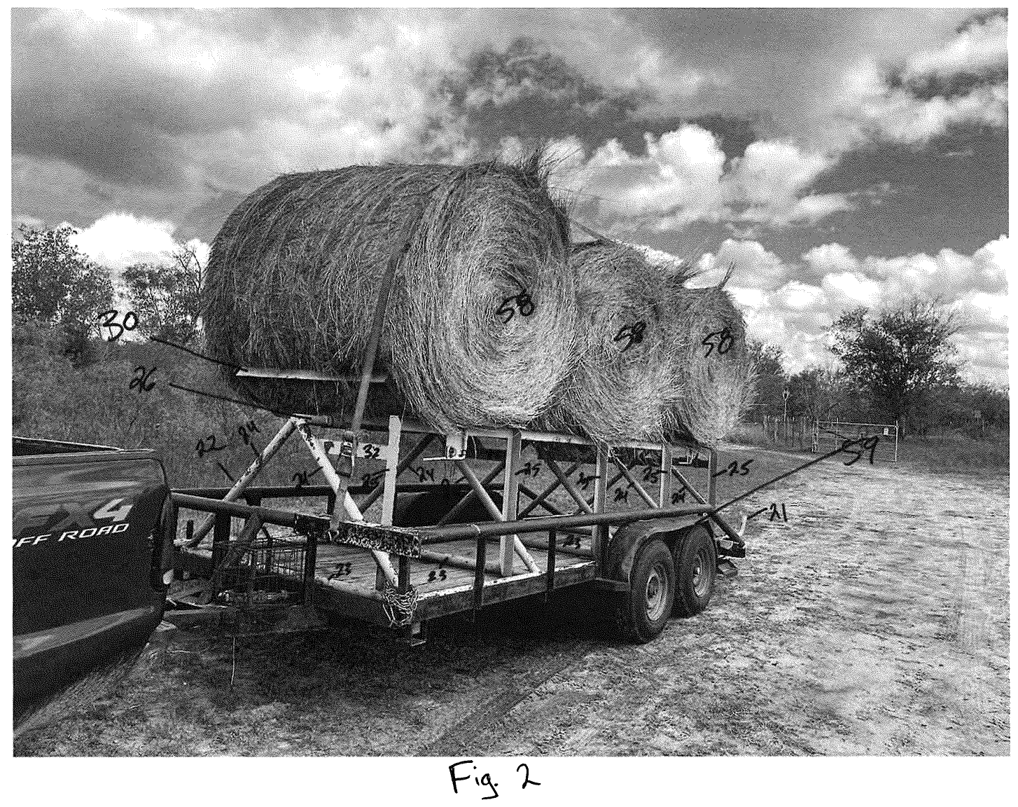

Operation of the hay skid is described with reference to FIGS. 2-7. The hay skid 20 is placed onto a trailer, truck bed, or other suitable surface for transporting the hay skid 20. This feature is one of the features that distinguishes the hay skid 20 from existing hay haulers. Existing hay haulers are trailers that can only be used to haul hay. The hay skid 20 described herein can be placed on a trailer so that the trailer can be used to haul hay, then removed from the trailer so the trailer can be used for other functions, then placed back onto the trailer when the user needs to haul hay again.

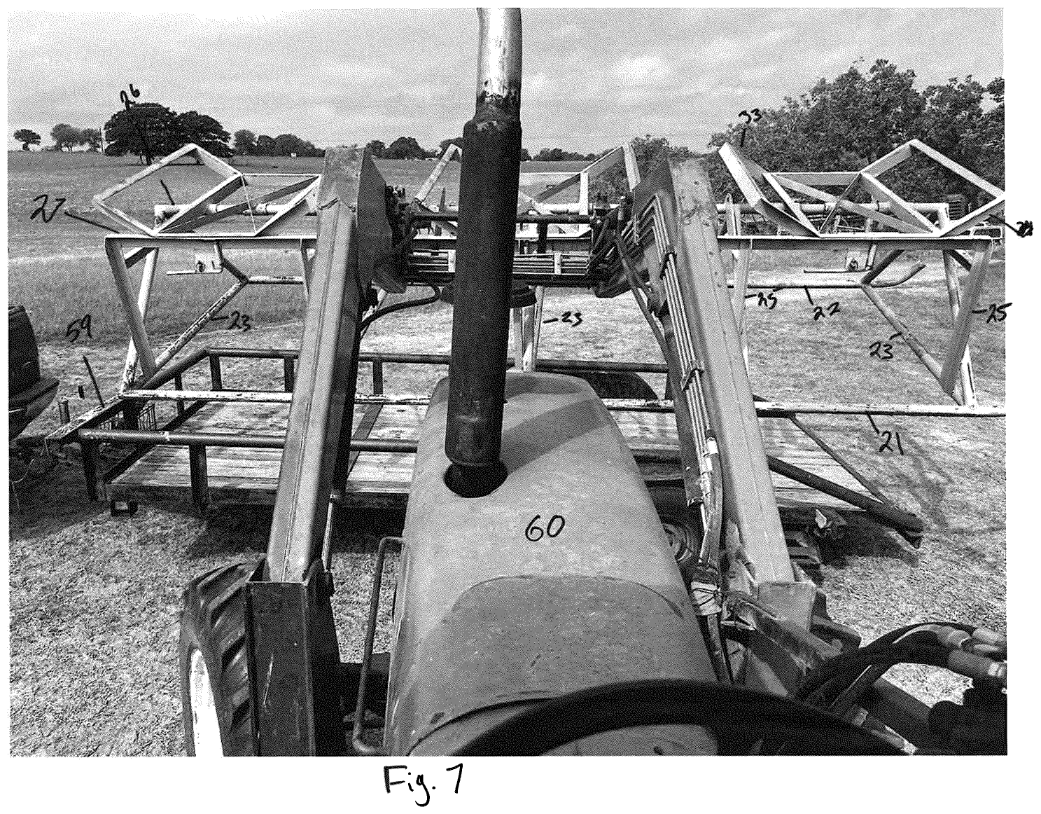

The hay skid 20 can be placed on a trailer 59 using a tractor 60, as shown in FIG. 7. Alternatively, the hay skid 20 can be stored in a hanging position from a tree or other structure. The hey skid 20 can then be placed on a trailer 59 by placing the trailer under the hanging hay skid 20, then lowering the hay skid 20 from the hanging position so that the hay skid 20 is placed onto the trailer 59. The hay skid 20 can be secured to the trailer 59 using chains, straps, or other suitable means. Alternatively, the user could rely solely on gravity and friction to secure the hay skid 20.

To load hay bales 58 onto the hay skid 20, the hay baskets 30 are locked into the closed position (as shown in FIG. 1). In the closed position, the top portion 44 of the first side 31 of the hay basket 30 frame 31 rests upon the top portion 28 of the crosspiece 27. When the hay basket 30 is in the closed position, the locking rod slot 45 of the hay basket 30 aligns with the locking rod slot 47 of the crosspiece 27.

When the rod locking slots 45 and 47 are aligned, the locking rod 50 can be rotated so that the first horizontal section 51 of the locking rod 50 moves into, or, out of, the combined locking slots 45 and 47. The user rotates the locking rod 50 by gripping the second horizontal section 53 and pulling or pushing. In the locked position, the first horizontal section 51 of the locking rod 50 extends through the locking slots 45 and 47. When the first horizontal section 51 of the locking rod 50 extends through the locking slots 45 and 47, the hay basket 30 cannot rotate on the shaft 26.

When the locking rod 50 is rotated into the locked position, the aperture 55 of the security flange 54 of the locking rod 50 surrounds the post 56 of the flange 48. The locking pin 57 can then be inserted through the aperture of the post 56. When inserted, the locking pin 57 prevents the locking rod 50 from being rotated, thus preventing the locking rod 50 from being moved from the locked position.

When the hay basket 30 is in the locked into the closed position, the hay basket 30 cannot rotate relative to the shaft 26.

Hay bales 58 are placed onto the hay baskets 30 using a tractor, forklift, or other suitable means. The hay bales 58 may be secured using straps or other suitable means, or just held in place by friction and gravity.

The operator can then transport the trailer with the loaded hay skid 20 to a desired location for a first hay bale 58.

When the operator desires to offload a first hay bale 58, the user unlocks the hay basket 30 holding the first hay bale 58. The user removes the locking pin 57 from the aperture of the post 56. The user then grips the second horizontal section 53 of the locking rod 50 and rotates the locking rod 50 away from the flange 48. The rotation of the locking rod 50 causes the first horizontal section 51 of the locking rod 50 to rotate out of the locking slots 45 and 47 so that the first horizontal section 51 of the locking rod no longer extends through the locking slots 45 and 47.

The user then applies upward pressure on the first side 33 of the hay basket 30, which will cause the hay basket 30 to rotate relative the shaft 26, via the connections between the collars 40, 41, and 42 and the shaft 26. The first side 33 of the hay basket 30 moves upward while the third side 35 moves downward, causing the hale bale 58 to fall off the hay basket 30.

In some embodiments, upward pressure from the user may not be required. The rotational collars 40, 41, and 42 can be positioned on the beams 37 38 and lattice 39 in an off-center position. The off-center positioning of the collars 40, 41, and 42 creates a weight imbalance. The weight imbalance can be used to make it easier or harder for the user to rotate the hay baskets 30. In other embodiments, hydraulics or other means of propulsion could be implemented in connection with rotating the hay baskets.

Once a hay bale 58 is off-loaded, the hay basket 30 is preferably rotated back to the closed position and locked back into the closed position to avoid unnecessary movement during transport.

The user can dump all three hay bales 58 at the same location or dump a first hay bale 58 at a first location then travel to a second location to dump a second hay bale 58.

The structure and operation of the hay skid 20 is generally being described with reference to a single hay basket 30 and corresponding locking mechanism. As shown in the Figures, the hay skid 20 may compromise multiple hay baskets and multiple locking mechanisms. The structure and operation of the additional hay baskets 30 and locking mechanisms are substantially identical to the hay basket 30 described herein. However, it is important to disclose that each hay basket and locking mechanism are separably operable. If the user needs to offload hay at three different locations, the user can unlock the first hay basket at a first location, the second hay basket at a second location, and the third hay basket at a third location. In other words, each hay basket is independently operable.

1. A hay skid comprising
a frame comprising a shaft;
a hay basket rotationally connected to the shaft of the frame; and
a locking mechanism that prevents the hay basket from rotating when the locking mechanism is in a locked position and allows the hay basket to rotate when the locking mechanism is in an open position.

2. The hay skid of claim 1 wherein:
the frame further comprises a first beam, a second beam, and at least one cross beam extending between the first beam and the second beam;
at least one A-frame support connected to the first beam, second beam and a cross beam; and
the shaft is integral the tops of the at least one A-frame support.

3. The hay skid of claim 2 wherein:
at least one vertical L-beam stanchion extends perpendicularly upward from the cross beam;
a horizontal L-beam support extends from the L-beam stanchion to the A-frame support proximate the top of the A-frame support.

4. The hay skid of claim 3 wherein:
an L-beam crosspiece is integral the top of the vertical L-beam stanchion.

5. The hay skid of claim 1 wherein:
the hay basket comprises a frame and a cylindrical collar integral the bottom of the frame;
an inner diameter of the cylindrical collar is larger than an exterior diameter of the shaft; and;
the cylindrical collar forms a rotational fit with the shaft.

6. The hay skid of claim 1 wherein:
the locking mechanism comprises a chute and a rod.

7. A hay skid comprising:
a frame having a shaft, a first beam, a second beam, at least one cross beam extending between the first beam and the second beam, at least one A-frame support connected to the first beam, second beam, and the at least one cross beam, the shaft integral the top of the at least one A-frame support, at least one vertical L-beam stanchion extending perpendicularly upward from a cross beam, a horizontal L-beam support extending from the L-beam stanchion to the at least one A-frame support proximate the top of the at least one A-frame support, and an L-beam cross piece integral the top of the at least one at least one vertical L-beam stanchion;
a hay basket having a frame with a first side, second side, third side, fourth side, first cross beam, second cross beam, and support lattice, a first cylindrical collar integral the bottom of the first cross beam, a second cylindrical collar integral the bottom of the of the support lattice; and a third cylindrical collar integral the bottom of the second cross beam;
a locking slot in the first side of the hay basket frame;
a locking slot in the L-beam cross piece of the hay skid frame;
a flange integral the L-beam cross piece of the hay skid frame;
a post with a pin hole extending out from the flange;
a locking pin;
a chute integral the flange;
a locking rod having a first horizontal section, a vertical section, a second horizontal section, and a flange; and
at least a portion of the vertical section of the locking rod enclosed within the chute; and
an aperture in the flange of the locking rod.

8. A method of hauling hay comprising the steps:
placing a hay skid on a trailer;
said hay skid having a frame comprising a shaft and at least one hay basket rotationally connected to the shaft;
said hay skid having a locking mechanism comprising a locking slot on the frame, a locking slot on the hay basket, and a locking rod configured to rotate in and out of alignment with the locking slots of the frame and hay basket;
rotating a hay basket so that the locking slot of the hay basket is aligned with the locking slot of the frame;
locking the hay basket to prevent rotation on the shaft by rotating the locking rod so that the locking rod extends through the locking slot of the hay skid and the locking slot of the hay basket;
loading at least one hay bale on the at least one hay basket;
transporting the trailer to a location;
rotating the locking rod so that the locking rod does not extend through the locking slot of the hay skid or the locking slot of the hay basket;
rotating the hay basket until the hay bale falls off the hay basket.

9. The method of hauling hay of claim 8 wherein:
the step of placing the hay skid on a trailer comprises lifting the hay skid with a tractor and placing it on a the trailer.

10. The method of hauling hay of claim 8 wherein:
the step of placing the hay skid on a trailer comprises placing the hay skid in a hanging position;
positioning the trailer underneath the hanging hay skid;
lowering the hay skid onto the trailer.

11. The method of claim 8 further comprising removing the hay skid from the trailer.

12. The method of claim 11 wherein:
removing the hay skid from the trailer comprises positioning a hook and rope configured to hang the hay skid;
attaching the hook to the hay skid;
raising the hay skid using the hook and rope; and
repositioning the trailer so the trailer is no longer under the hay skid.

13. The method of claim 8 wherein:
said at least one hay basket comprises three hay baskets;
said at least one hay bale comprises three hay bales;
transporting the trailer to a second location;
unloading the second hay bale by rotating the locking rod of the second hay basket so that the locking rod does not extend through the locking slot of the hay skid or the locking slot of the second hay basket and rotating the second hay basket until the second hay bale falls off the second hay basket;
transporting the trailer to a third location; and
unloading the third hay bale by rotating the locking rod of the third hay basket so that the locking rod does not extend through the locking slot of the hay skid or the locking slot of the third hay basket and rotating the third hay basket until the third hay bale falls off the third hay basket.
